(19) United States
(12) Patent Application Publication
(10) Pub. No.: US 2022/0354090 A1
(43) Pub. Date: Nov. 10, 2022

(54) Retractable Leash Device

(71) Applicants: Jamis Medeiros, Leadville, CO (US); Kori Medeiros, Leadville, CO (US)

(72) Inventors: Jamis Medeiros, Leadville, CO (US); Kori Medeiros, Leadville, CO (US)

(21) Appl. No.: 17/732,685

(22) Filed: Apr. 29, 2022

Related U.S. Application Data
(60) Provisional application No. 63/186,485, filed on May 10, 2021.

(51) Int. Cl. A01K 27/00

(52) U.S. Cl. CPC A01K 27/005; A01K 27/004; A01K 27/008

(57) ABSTRACT

The present invention relates to a retractable leash device primarily comprised of a housing, a disk, a leash and a harness and/or collar. The housing is preferably circular and houses a rotating and locking disk, wherein the housing attaches magnetically to a flat bottom member and the member attaches to a magnet located on the harness or collar. The disk further receives a leash that can be retracted within the housing around the disk for storage when not in use. In addition, one embodiment of the device may allow for the attachment of a second device that has an additional tether, such that a user can tether a second animal to the device as it is worn by a first animal. Therefore, a user can walk multiple animals using only one leash, and wherein the tether can still be stored within the housing when not in use.

### CROSS-REFERENCE TO RELATED APPLICATION

The present application claims priority to, and the benefit of, U.S. Provisional Application No. 63/186,485, which was filed on May 10, 2021, and is incorporated herein by reference in its entirety.

### FIELD OF THE INVENTION

The present invention relates generally to the field of dog leashes. More specifically, the present invention relates to a retractable dog leash device primarily comprised of a housing, a disk, a leash and a harness and/or collar. The housing is preferably circular and houses a rotating and locking disk, wherein the housing attaches magnetically to a flat bottom member and the member attaches to a magnet located on the harness or collar. The disk further receives a leash that can be retracted within the housing around the disk for storage when not in use. In addition, one embodiment of the device may allow for the attachment of a second device that has an additional tether, such that a user can tether a second animal to the device as it is worn by a first animal. Therefore, a user can walk multiple animals using only one leash, and wherein the tether can still be stored within the housing when not in use. Accordingly, the present disclosure makes specific reference thereto. Nonetheless, it is to be appreciated that aspects of the present invention are also equally applicable to other like applications, devices and methods of manufacture.

### BACKGROUND

Typically, a leash is a rope or strap that is attached to a collar, harness or halter to control a dog or other animal while walking in public areas. Walking a dog on a leash protects both the dog and other nearby individuals or pets by providing a safe and simple way to control the dog and prevent the dog from chasing, lunging at and/or injuring other individuals or animals. Leashes are available in a wide range of lengths, widths and designs. Existing dog leashes include adjustable dog leashes, chain leashes, reflective leashes, martingale leashes, double leashes, etc.

A standard dog leash is usually made of nylon or leather, both of which are strong enough to restrain an adult dog. Further, a choke chain may be highly effective, but if used incorrectly may cause injury or even death to the animal as it tightens around the animal's neck when more pressure is applied. Adjustable leashes also offer freedom to pets, however adjustments to said leashes are generally made between 3 and 6 feet by adding or removing loops or additional clips along the length of the leash. Retractable leashes are also available, wherein the leash retracts into a housing. However, the housing must still be carried by an individual, even after detaching the leash from a dog collar/harness to allow a dog to roam freely. This is extremely undesirable, as it unnecessarily occupies the hand of the user, which may otherwise be needed to be free to complete a variety of other tasks.

Therefore, there exists a long-felt need in the art for an improved dog leash. There also exists a long-felt need in art for an improved retractable dog leash. Further, there exists a long-felt need in the art for a retractable leash device that does not require a user to hold the device when it is not being used to control a dog.

The subject matter disclosed and claimed herein, in one embodiment thereof, comprises a retractable leash device. The device is primarily comprised of a housing, a disk, a leash and a harness and/or collar. The housing is preferably circular and houses a rotating and locking disk. The housing preferably attaches magnetically to a flat bottom member, wherein the flat bottom member attaches to a magnet located on the harness or collar. The disk further receives a leash that can be retracted within the housing around the disk for storage when not in use. In addition, one embodiment of the device may allow for the attachment of a second device that has an additional tether, such that a user can tether a second animal to the device as it is worn by a first animal. Therefore, a user can walk multiple animals using only one leash, and wherein the tether can still be stored within the housing when not in use.

In this manner, the retractable leash device of the present invention accomplishes all of the forgoing objectives and provides a retractable leash that does not require a user to hold the device when it is not being used to control a dog or other animal. Further, the device allows a user to easily walk multiple dogs/animals, such that only one leash is needed to control multiple animals. In addition, the device is also extremely versatile as it can be used with a harness or collar and can easily be removed from said harness or collar as desired.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a retractable leash device. The device is primarily comprised of a housing, a disk, a leash and a harness and/or collar. The housing is preferably circular and houses a rotating and locking disk. The housing preferably attaches magnetically to a flat bottom member, wherein the flat bottom member attaches to a magnet located on the harness or collar. In differing embodiments, the side surface and top surface of the housing may be comprised of any number of indicia, such as but not limited to: patterns, logos, emblems, images, symbols, designs, letters, words, characters, animals, advertisements, brands, contact information (i.e., phone number/addresses), etc.

The disk is further located within the housing and can rotate three-hundred and sixty degrees around a shaft. The disk is comprised of a loop, wherein a leash can attach to the loop via a metal clip that is placed through a continuous opening in the housing. In an alternative embodiment, the leash may be magnetically attached to the disk. Therefore, the rotation of the disk allows the leash to become shorter or longer in length. The rotation of the disk can further be locked/unlocked via a button located on the housing.

The device may also be comprised of a collar and a harness, wherein each can be secured on a dog or other animal. The harness further has a plurality of harness straps that can be removably-secured around the torso/legs of a dog via at least one fastener, such as but not limited to: a buckle, a hook and loop strap, a snap-button, etc. In addition, the bottom surface of the harness may be comprised of a fixedly-attached or removable soft padding to increase the comfort of the dog. The top surface may also be comprised of an integrated, fixedly-attached magnet to allow the bottom member to magnetically attach to a point on the harness. Similarly, the collar can be removably-secured around the neck of a dog via a fastener such as a buckle, hook and loop strap, snap-button, etc. In addition, the bottom surface of the collar may be comprised of a removable or removably-secured soft padding to increase the comfort of the dog, and the top surface may also be comprised of an integrated, removably-secured magnet to allow the bottom member to magnetically attach to the collar. In differing embodiments, the harness and collar may be of any size necessary to accommodate any size dog or other animal that may wear the harness or collar.

The leash of the device is also preferably comprised of an adjustable slip-loop that can be placed around the hand of a user. The leash may contain a doggy bag holder and a plurality of doggy bags. In differing embodiments, the leash may be manufactured of a plurality of materials such as but not limited to: nylon, leather, cotton, rubber, braided metal, chain, etc. In addition, the device may comprise a kit of a plurality of leashes, wherein each leash may differ in length or type or material.

Two devices may also be used simultaneously on two dogs/animals to allow a user to control both dogs/animals via a singular leash. A first device is attached to a harness/collar of a dog. Then, a second device is attached to a harness/collar of a second dog. However, the second device also contains a tether that is comprised of a first clip and a second clip. Similar to a clip of the leash, the first clip of the tether can be secured to the loop of the disk of the device located on the second dog. The device located on the first dog also has an additional loop located on the outside surface of the housing that receives the second clip of the tether. This in turn allows the tether to attach to the housing of the device on the first dog and the disk of the device on the second dog. As a result, the devices on each dog are linked, such that a user can then use the leash of the device on the first dog to control both dogs. If the user then desires to disconnect the tether, the tether can be retracted into the housing of the device of the second dog in a manner identical to how the leash retracts into the housing of the device attached to the first dog. Therefore, the user need not carry the tether when not in use.

Accordingly, the retractable leash device of the present invention is particularly advantageous as it allows a user to utilize a retractable leash device but does not require a user to hold the device when it is not being used to control a dog. Further, the device allows a user to easily walk multiple dogs/animals, wherein only one leash is needed to control said animals. The device is also extremely versatile as it can be used with a harness or collar and can easily be removed from said harness or collar as desired.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a retractable leash device of the present invention in accordance with the disclosed architecture;

FIG. 2 illustrates a cross-sectional view of one embodiment of a retractable leash device of the present invention in accordance with the disclosed architecture;

FIG. 3A illustrates a perspective view of one embodiment of a retractable leash device of the present invention being worn by a dog in accordance with the disclosed architecture;

FIG. 3B illustrates a perspective view of one embodiment of a retractable leash device of the present invention in use in accordance with the disclosed architecture;

FIG. 3C illustrates a top perspective view of one embodiment of a tactical vest for retaining the retractable leash device of the present invention in accordance with the disclosed architecture;

FIG. 4 illustrates a perspective view of one embodiment of a retractable leash device of the present invention wherein the dog is being walked by a user in accordance with the disclosed architecture; and

FIG. 5 illustrates a top view of one embodiment of two retractable leash devices of the present invention being worn by two dogs in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved dog leash. There also exists a long-felt need in art for an improved retractable dog leash. Further, there exists a long-felt need in the art for a retractable leash device that does not require a user to hold the device when it is not being used to control a dog.

The present invention, in one exemplary embodiment, is comprised of a retractable leash device primarily comprised of a housing, a disk, a leash and a harness and/or collar. The housing is preferably circular, and houses a rotating and locking disk. In addition, the housing preferably attaches magnetically to a flat bottom member, wherein the flat bottom member attaches to a magnet located on the harness or collar. In differing embodiments, the side surface and top surface of the housing may be comprised of any number of indicia, such as but not limited to: patterns, logos, emblems, images, symbols, designs, letters, words, characters, animals, advertisements, brands, contact information (e.g. phone number/addresses), etc.

Furthermore, the disk is located within the housing, and rotates three-hundred and sixty degrees around a shaft. Therefore, the rotation of the disk allows the leash to become shorter or longer in length. The rotation of the disk can further be locked/unlocked via a button located on the housing. The disk is also comprised of a loop, wherein a leash can attach to the loop via a metal clip that is placed through a continuous opening in the housing. In an alternative embodiment, the leash may be magnetically-attached to the disk.

The device may also be comprised of a collar and/or a harness, wherein each of the same can be secured on a dog or other animal. The harness further has a plurality of harness straps that can be removably-secured around the torso/legs of a dog via at least one fastener, such as but not limited to: a buckle, a hook and loop strap, a snap-button, etc. In addition, the bottom surface of the harness may be comprised of a removably-secured or removable soft padding to increase the comfort of the dog. The top surface may also be comprised of an integrated, fixedly-attached magnet to allow the bottom member to magnetically attach to a point on the harness. Similarly, the collar can be removably-secured around the neck of a dog via a fastener, such as a buckle, hook and loop strap, snap-button, etc. In addition, the bottom surface of the collar may be comprised of a removable or removably-secured soft padding to increase the comfort of the dog, and the top surface may also be comprised of an integrated, fixedly-attached magnet to allow the bottom member to magnetically attach to the collar. In additional embodiments, the harness and collar may be of any size necessary to accommodate any size dog or other animal that may wear the harness or collar.

The leash of the device is also preferably comprised of an adjustable slip-loop that can be placed around the hand of a user, wherein the leash may contain a doggy bag holder and a plurality of doggy bags. The leash may also be manufactured of a plurality of materials, such as but not limited to: nylon, leather, cotton, rubber, braided metal, chain, etc. The device may comprise a kit of a plurality of leashes, wherein each leash may differ in length or type of material.

Further, two devices may be used simultaneously on two dogs/animals to allow a user to control both dogs/animals via a singular leash, wherein a first device is attached to a harness/collar of a dog, and a second device is attached to a harness/collar of a second dog. However, the second device also contains a tether that is comprised of a first clip and a second clip. Similar to the clip of the leash, the first clip of the tether can be secured to the loop of the disk of the device located on the second dog. The device located on the first dog also has an additional loop located on the outside surface of the housing that receives the second clip of the tether, which allows the tether to attach to the housing of the device on the first dog and the disk of the device on the second dog. Therefore, the devices on each dog are linked such that a user can then use the leash of the device on the first dog to control both dogs, and if the user then desires to disconnect the tether it can be retracted into the housing of the device of the second dog in a manner identical to how the leash retracts into the housing of the device attached to the first dog. Therefore, the user need not carry the tether when not in use.

Accordingly, the retractable leash device of the present invention is particularly advantageous as it allows a user to utilize a retractable leash device, but does not require a user to hold the device when it is not being used to control a dog. Further, the device allows a user to easily walk multiple dogs/animals, wherein only one leash is needed to control said animals. The device is also extremely versatile, as it can be used with a harness or collar and can easily be removed from said harness or collar as desired.

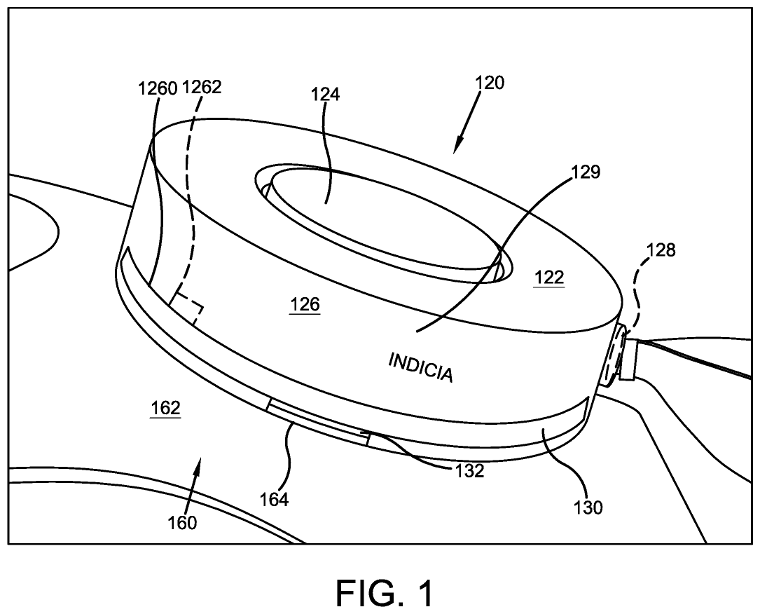

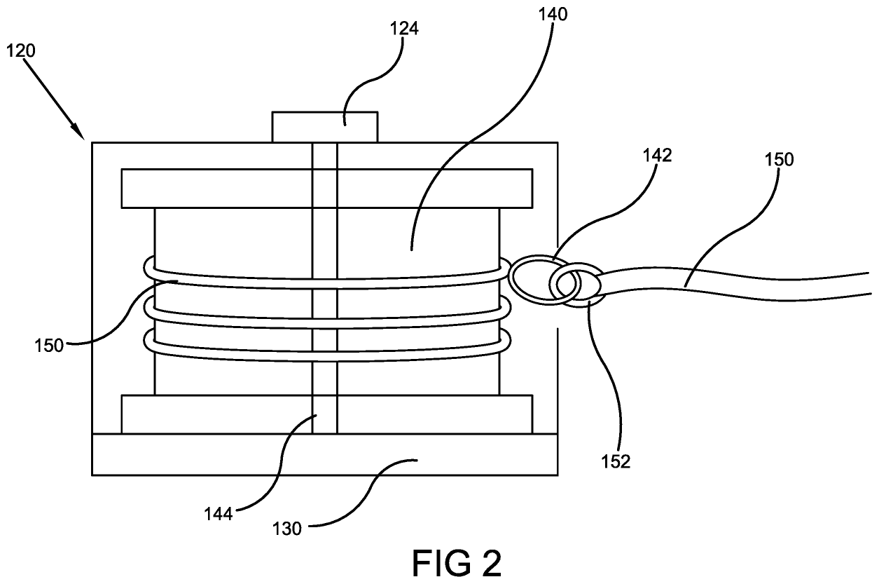

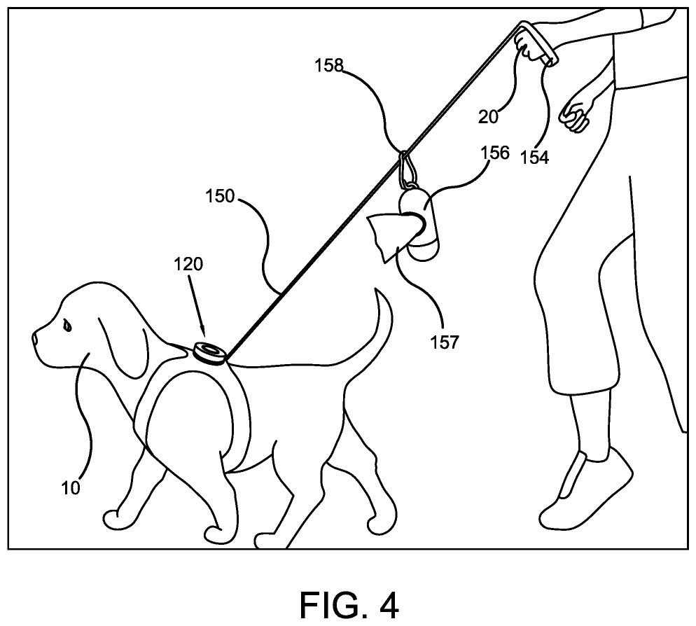

Referring initially to the drawings, FIG. 1 illustrates a perspective view of one embodiment of a retractable leash device 100 of the present invention. The device 100 is primarily comprised of a housing 120, a rotating and locking disk 140 (shown in FIG. 2), a leash 150 (shown in FIG. 2) and a harness 160 (shown in FIG. 2) and/or collar 170 (shown in FIG. 4). The housing 120 is preferably circular in shape, but in differing embodiments may be any suitable shape known in the art, such as but not limited to: square, rectangular, triangular, octagonal, etc. The housing 120 may also be manufactured from a durable metal such as aluminum, a magnetic metal or any suitable material that has been magnetized as is known in the art. The housing 120 may alternatively be manufactured of a plastic, such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., or any other suitable plastic material as is known in the art. The housing 120 is removably-secured to a flat bottom member 130, wherein the bottom member 130 is also magnetic and is preferably manufactured from the same material as the housing 120. The flat bottom member 130 comprises an embedded magnet 132 which allows the housing 120 to magnetically attach to the flat bottom member 130. In an embodiment wherein the housing 120 is magnetic, the bottom edge 1260 of the side surface 126 is magnetically-secured to the bottom member 130. In an embodiment wherein the housing 120 is plastic, the bottom edge 1260 of the housing 120 may contain a plurality of embedded magnets 1262, which allow the housing 120 to magnetically attach to the magnetic bottom member 130.

In one embodiment, the housing 120 and bottom member 130 may be one continuous piece (i.e. wherein the bottom member 130 is fixedly-secured to the housing 120). The side surface 126 and top surface 122 may further be comprised of any number of indicia 129, such as but not limited to: patterns, logos, emblems, images, symbols, designs, letters, words, characters, animals, advertisements, brands, contact information (i.e. phone number/addresses), etc., or any other suitable indicia as is known in the art. As will be explained more fully below, the device 100 is comprised of a harness 160 and/or collar 170, wherein the harness 160 and collar 170 are comprised of a magnet 164, 174 that allows the bottom member 130 to magnetically attach to the harness 160 or collar 170.

FIG. 2 illustrates a cross-sectional view of one embodiment of the retractable leash device 100 of the present invention. A plastic or metal disk 140 is further stored within the housing 120, wherein the disk 140 can rotate three-hundred and sixty degrees around a shaft 144. The disk 140 is further comprised of a fixedly-secured plastic or metal loop 142, wherein the loop 142 can receive a clip 152 of a leash 150 through a continuous opening 128 (shown in FIG. 1) in the side surface 126. In this regard, the leash 150 is removably-secured to the disk 140, and wherein the rotation of the disk 140 allows the leash 150 to become shorter or longer by wrapping/unwrapping around the disk 140. In one embodiment, the disk 140 and clip 152 may both be magnetic, such that the clip 142 can magnetically secure to the disk 140. As a result, the leash 150 can be easily removed in any embodiment if it becomes damaged and needs replaced.

Furthermore, the rotation of the disk 140 can be locked or unlocked via pressing a button 124 located on the top surface 122 of the housing 120. The button 124 controls the rotation of the shaft 144. Therefore, the leash 150 can be secured at a predetermined length chosen by the user 20 (shown in FIG. 4). Further, the overall length of the leash 150 may be any suitable length in any embodiment to meet the wants and/or needs of a user. The disk 140 may also be removably or fixedly-attached to the shaft 144 via any suitable securing means as is known in the art, wherein the shaft 144 may be removably or fixedly-attached to the housing 120, the button 124, and/or the bottom member 130 via any suitable securing means as is known in the art.

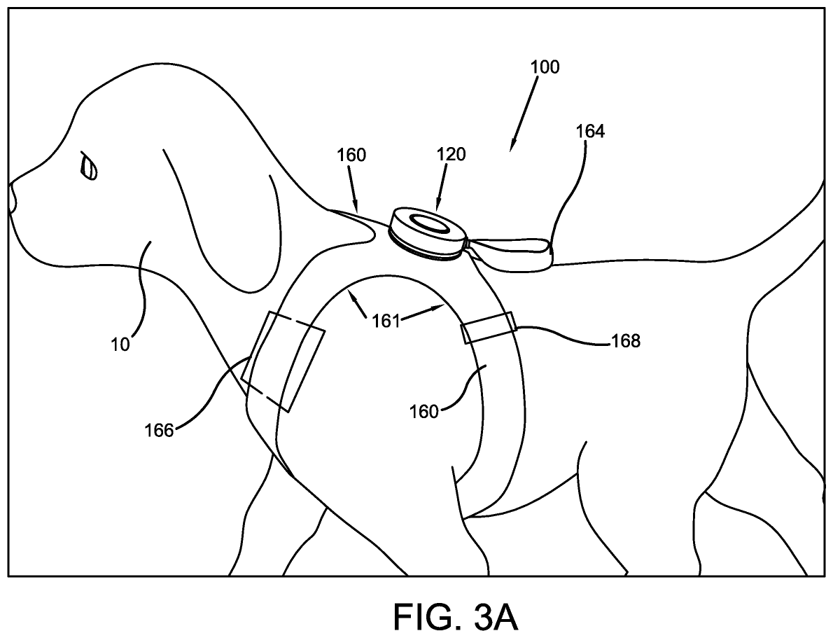

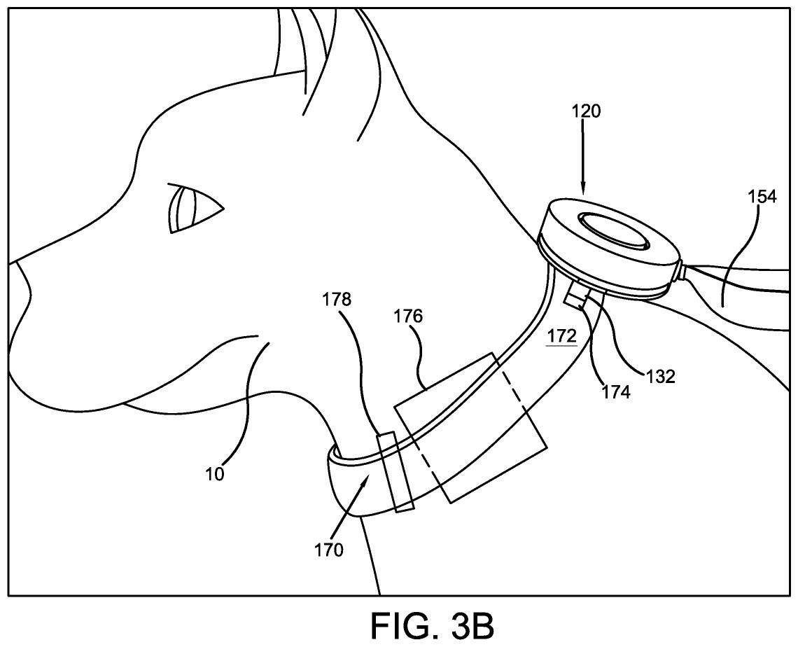

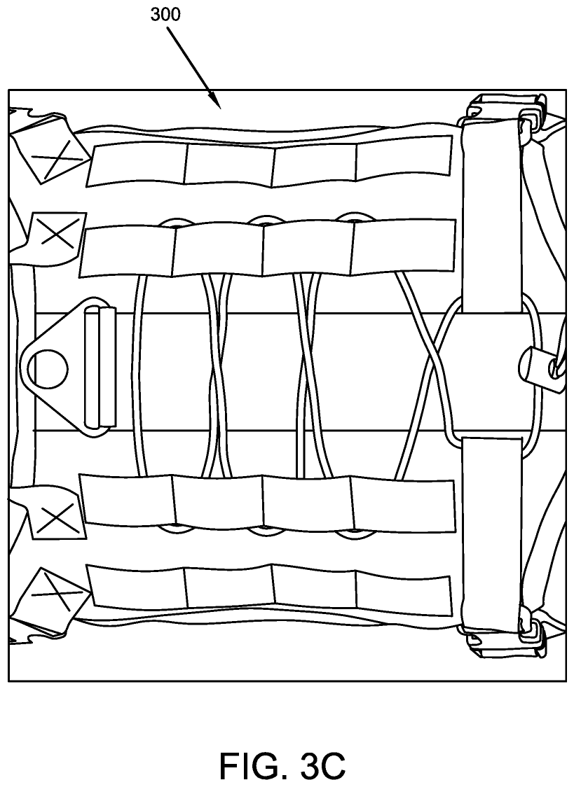

FIG. 3A illustrates a perspective view of one embodiment of the retractable leash device 100 of the present invention being worn by a dog 10. As noted, the device 100 may be comprised of a harness 160 with a plurality of harness straps 161 that can be removably-secured around the torso/legs of a dog 10 via at least one fastener 168, such as but not limited to: a buckle, a hook and loop strap, a snap-button, etc., or any other suitable fastener as is known in the art. In addition, the bottom surface of the harness 160 may be comprised of a fixedly-secured or removable soft padding 166 to increase the comfort of the dog 10 wearing the harness 160. As stated supra, the top surface 162 may also be comprised of an integrated, fixedly-secured magnet 164 which allows the bottom member 130 to magnetically secure to a point on the harness 160.

FIG. 3B illustrates a perspective view of one embodiment of the retractable leash device 100 of the present invention in use. The device 100 may also be comprised of a collar 170 that can be removably-secured around the neck of a dog 10 via a fastener 178, such as a buckle, hook and loop strap, snap-button, etc., or any other suitable securing means as is known in the art. In addition, the bottom surface of the collar 170 may be comprised of a removably or fixedly-attached soft padding 176 to increase the comfort of the dog 10 wearing the collar 170. As stated supra, the top surface 162 may also be comprised of an integrated, fixedly-secured magnet 174 which allows the bottom member 130 and integrated magnet 132 to magnetically secure to the collar 170. In differing embodiments, the harness 160 and collar 170 may be of any size necessary to accommodate any size dog or other animal that may wear the harness 160 or collar 170.

FIG. 3C illustrates a top perspective view of one embodiment of the harness 160 for retaining the retractable leash device 100 of the present invention. In this embodiment, the harness comprises a tactical vest 300 with a nylon front clip for a dog or other animal. The retractable leash device 100 can then be secured to the tactical vest 300 in much the same way as the harness 160 is secured to the retractable leash device 100. For example, the top surface 162 may also be comprised of an integrated, fixedly-secured magnet 164, which allows the bottom member 130 to magnetically secure to a point on the tactical vest 300.

FIG. 4 illustrates a perspective view of one embodiment of the retractable leash device 100 of the present invention in use, and wherein the dog 10 is being walked by a user 20. The leash 150 may further be comprised of an adjustable slip-loop 154 that allows a user 20 to secure the leash 150 to his or her hand or beltloop. The leash 150 may also be comprised of a doggy bag holder 156 that attaches to the leash via a clip 158, wherein the holder 156 may also contain plastic and/or biodegradable doggy bags 157. In addition, the device 100 may comprise a kit of a plurality of leashes 150, wherein each leash 150 is of a different length. In addition, the leashes 150 in any embodiment of the device 100 may be comprised of a plurality of materials, such as but not limited to: nylon, leather, cotton, rubber, braided metal, chain, etc., or any other suitable material as is known in the art.

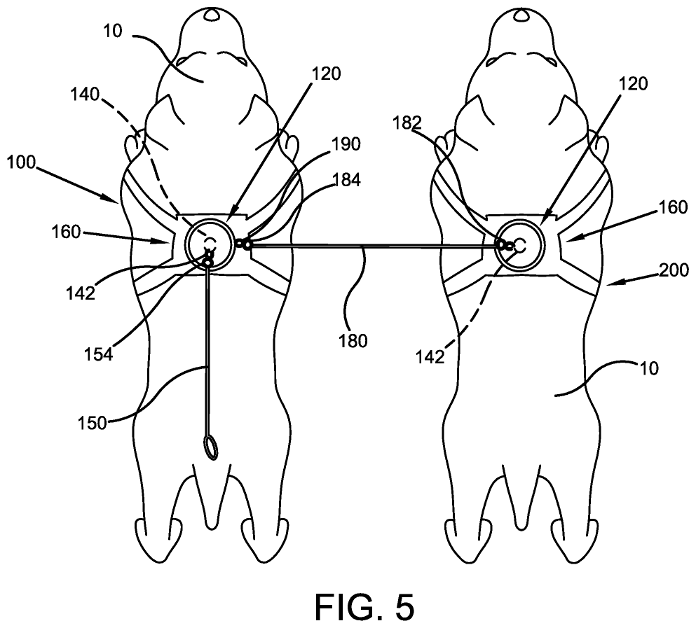

FIG. 5 illustrates a top view of one embodiment of the retractable leash device 100 of the present invention being worn by two dogs 10. In one embodiment, the device 100 can be linked to a second device 200 to allow a user 20 to walk two dogs 10 simultaneously via one leash 150. Specifically, the first device 100 is attached to the harness 160 or collar 170 of a first dog 10 as described supra. The second device 200 is then attached to the harness 160 or collar 170 of a second dog 10. However, the second device 200 attached to the second dog 10 contains an additional tether 180. The tether 180 is comprised of a first clip 182 and a second clip 184. Like the clip 152 of the leash 150, the clip 182 can be secured to the loop 142 of the disk 140 of the second device 200 located on the second dog 10. However, the device 100 located on the first dog has an additional metal or plastic loop 190 located on the outside surface of the housing 120. This loop 190 receives the second clip 184 of the tether 180, to allow the tether 180 to attach to the housing 120 of the device 100 on the first dog 10, and the disk 140 of the second device 200 on the second dog 10. Accordingly, the second device 200 of the second dog 10 is linked to the device 100 of the first dog 10, wherein the user 20 can then use the leash 150 of the device 100 on the first dog 10 to control both dogs 10. If the user 20 then desires to disconnect the tether 180, the tether 180 can be retracted into the housing 120 of the second device 200 of the second dog 10, in a manner identical to how the leash 150 would retract into the housing 120 of the device 100 attached to the first dog 10. It should be appreciated that the devices 100, 200 may have has many loops 190 as needed to allow a user to link any number of dogs/animals to a single device 100, 200, thereby allow a user to walk a plurality of animals using only one leash 150.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “retractable leash device” and “device” are interchangeable and refer to the retractable leash device 100 of the present invention.

Notwithstanding the forgoing, the retractable leash device 100 of the present invention and its various components can be of any suitable size and configuration as is known in the art without affecting the overall concept of the invention, provided that they accomplish the above-stated objectives. One of ordinary skill in the art will appreciate that the size, configuration and material of the retractable leash device 100 as shown in FIGS. 1-5 is for illustrative purposes only, and that many other sizes and shapes of the retractable leash device 100 are well within the scope of the present disclosure. Although the dimensions of the retractable leash device 100 are important design parameters for user convenience, the retractable leash device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A retractable leash device comprising:
a housing removably secured to a flat bottom member;
a disk stored within the housing, wherein the disk rotates three-hundred and sixty degrees around a shaft;
a leash removably secured to the disk, wherein the rotation of the disk allows the leash to become shorter or longer by wrapping/unwrapping around the disk;
a harness; and
a collar, wherein the harness and collar are comprised of a magnet that allows the flat bottom member to magnetically attach to the harness or collar, and further wherein the leash can be retracted into the housing around the disk when not in use.

2. The retractable leash device of claim 1, wherein the disk comprises a fixedly secured loop.

3. The retractable leash device of claim 2, wherein the loop receives a clip of a leash.

4. The retractable leash device of claim 3, wherein the disk and the clip are both magnetic such that the clip can magnetically secure to the disk.

5. The retractable leash device of claim 1, wherein the flat bottom member is magnetic which allows the housing to magnetically attach to the flat bottom member.

6. The retractable leash device of claim 1, wherein the housing comprises a plurality of embedded magnets which allow the housing to magnetically attach to the flat bottom member.

7. A retractable leash device comprising:
a housing that attaches to a bottom member;
a disk within the housing, wherein the disk rotates three-hundred and sixty degrees around a shaft;
a leash that removably attaches to the disk;
a harness, wherein the bottom member can magnetically attach to the harness; and
a collar, wherein the bottom member can magnetically attach to the collar, wherein the leash can fully retract around the disk into the housing when not in use, and further wherein the rotation of the disk can be locked or unlocked via pressing a button located on a top surface of the housing.

8. The retractable leash device of claim 7, wherein the disk rotates within the housing to allow the leash to become shorter or longer in length.

9. The retractable leash device of claim 7, wherein the button controls the rotation of the shaft and a length of the leash which is released from around the shaft.

10. A retractable leash device comprising:
a housing that attaches to a bottom member;
a disk that can rotate three-hundred and sixty degrees within the housing, wherein the disk is further comprised of a loop;
a leash comprised of an adjustable slip loop and a doggy bag holder, wherein the leash removably attaches to the disk via the loop of the disk;
a harness comprised of an integrated magnet, wherein the bottom member can magnetically attach to the harness; and
a collar comprised of an integrated magnet, wherein the bottom member can magnetically attach to the collar.

11. The retractable leash device of claim 10, wherein the housing and the bottom member are magnetic.

12. The retractable leash device of claim 11, wherein the housing magnetically attaches to the bottom member

13. The retractable leash device of claim 10, wherein a side surface and/or a top surface of the housing is comprised of any number of indicia such as a pattern, a logo, an emblem, an image, a symbol, a design, a letter, a word, a character, an animal, an advertisement, a brand, a phone number, or an address.

14. The retractable leash device of claim 10, wherein a side surface of the housing is comprised of a continuous opening that allows the leash to removably connected to the disk within the housing.

15. The retractable leash device of claim 10, wherein a top surface of the housing is comprised of a button that allows a user to lock or unlock the rotation of the disk.

16. The retractable leash device of claim 10, wherein the doggy bag holder attaches to the leash via a clip.

17. The retractable leash device of claim 10, wherein the housing is further comprised of a loop on an outside surface of the housing.

18. The retractable leash device of claim 10 further comprising a tether that can attach to the disk and to the loop on the outside surface of the housing.

19. The retractable leash device of claim 18, wherein the tether can be used to attach one retractable leash device that is worn by a first animal to another retractable leash device worn by a second animal.

20. The retractable leash device of claim 19, wherein the leash of one retractable leash can be used to control both the first animal and the second animal, and wherein the tether can be retracted into the housing when not in use.
